(19) United States
(12) Patent Application Publication
(10) Pub. No.: US 2021/0213402 A1
(43) Pub. Date: Jul. 15, 2021

(54) Stirring Apparatus and Method

(71) Applicant: Edwin Cox, Spartanburg, SC (US)

(72) Inventor: Edwin Cox, Spartanburg, SC (US)

(21) Appl. No.: 16/738,548

(22) Filed: Jan. 9, 2020

(51) Int. Cl. B01F 7/00; B01F 3/04; B01F 13/00

(52) U.S. Cl. CPC B01F 7/001; B01F 2215/0026; B01F 13/0028; B01F 3/04453

(57) ABSTRACT

A stirring apparatus includes a power tool such as a drill or cordless screwdriver, and a stirring bit that may be removably inserted into the power tool in the conventional manner for stirring a liquid or any other material that requires stirring or agitation for proper use or consumption. The stirring bit, in a preferred embodiment, is a generally longitudinal structure having a first and a second end, where the first end includes a hexagonal cross section, similarly to any standard drill bit, and a second end that include a clamp mechanism. The clamp mechanism is used for attaching a stirring stick or paddle to the stirring bit. In another embodiment, the stirring bit may include a beater or frothing mechanism, rather than the clamp mechanism.

### FIELD OF THE INVENTION

The present invention relates to devices used for stirring or agitating fluids or other materials, such as coffee, paint, concrete, stain, or the like. More specifically, the present invention includes a stirring bit that may be attached to any drill, cordless screwdriver or the like, and which may be inserted into a container having material that needs to be stirred or agitated.

### BACKGROUND OF THE INVENTION

There are many powered devices that are used to stir or mix fluids or other materials on the market today, including mixers for kitchen use, blenders, and stirring devices for things like cans of paint. Some of these devices include motors that are used to rotate agitating devices that are removable from the unit (similarly to a kitchen mixer, where the beaters may be removed from the mixer for cleaning and storage purposes). There are even devices available today for frothing milk for coffee, and for stirring cocktails, coffee or the like.

The following documents show a variety of different stirring and agitating devices, which are used for a variety of purposes. Each of the documents discussed below are hereby incorporated herein by reference, in their entireties:

U.S. Pat. No. 3,972,512 Mixing Materials in Containers

A container for materials to be mixed e.g., paint, said container having a removable plug in an aperture, said plug being removable for adding materials to the mixture, the plug having a diaphragm to be pierced by a single sharp mixing member and including means to rotate the mixing member while the container is completely closed. The mixing member is a needle or the like having its major portion at an angle to the axis of the means rotating it.

U.S. Pat. No. 4,422,770 Paint Stirrer

An electric drill powered paint stirrer for stirring paint in a conventional paint marketing can of the kind normally closed for sale by a lid. A second lid is substitutable on the can for the marketing lid and has a central opening. A stirring rod assembly is releasably securable in the second lid. The assembly comprises a bushing element having a reduced diameter externally threaded and extending from a shoulder. The bushing has a central through bore. The second lid opening is of diameter to snugly receive the threaded bushing end therethrough but not the shoulder. The assembly further includes a stirring rod having an upstanding shank extending upward through the bushing. The rod has upper and lower radially widened portions closely flanking the upper and lower ends of the bushing for axially locating the shank in the bushing. The rod has a bottom portion depending from the shank and sized to lie close to the can peripheral wall and bottom for stirring paint in the marketing can. A nut is threadable on the threaded bushing end to clamp the second lid against the shoulder of the bushing.

U.S. Pat. No. 5,439,236 Apparatus for Supporting a Paint Stirring Stick and for Coupling to an Electric Drill

An apparatus for supporting a paint stirring stick and for coupling to an electric drill comprising, in combination, a generally box-like container, the container having large parallel upper and lower walls, and small parallel side walls coupled therebetween, the container having an open front end adapted to receive a stirring stick, the device also having a closed rear end formed of symmetric walls adapted to close the rear end of the container.

U.S. Pat. No. 5,586,676 Beverage Container Cap with Stirrer

A drinking container cap is provided having an exterior surface, and an interior surface, with the interior surface having a stirrer depending downwardly therefrom. Preferably the interior surface has formed thereon a stirrer receptacle, with the stirrer receptacle itself being generally cylindrical. The stirrer mechanically engages with the stirrer receptacle, and is detachable therefrom. The stirrer receptacle has an inner and an outer surface, with an indentation in its inner surface. The stirrer has a shank end and a terminal end, with the shank end having a bulged area which engages with the indentation, and the terminal end having a bowl portion. In the preferred embodiment of the invention the stirrer receptacle has two notches formed therein, and the stirrer has two projections extending outwardly from the shank end, with the notches being on opposite sides of the stirrer receptacle and the projections being on opposite sides of the stirrer.

U.S. Pat. No. 5,938,325 Stirring Rod with Flexible Extensions for Mixing Materials

An elongate rod having a first end or end area and an oppositely disposed second end or end area, the first end suitably structured for connecting to a rotary drive such as the chuck of a hand held drill type motor, food blender drive or the like for example, and the second end area including attached flexible line members extending generally perpendicular to the length of the elongate rod. In a preferred embodiment, the flexible line members are made of resilient plastics material such as lawn and weed trimmer type line. Additionally preferred is the line members being retained such that they extend on one side of the rod at a slight angle downward to extend below the terminal end of the second end of the rod for allowing stirring against a container bottom surface, and extend on an opposite side of the rod at a slight angle upward for allowing stirring against a container top surface or lid. The flexible line members are preferably removably connected to the rod via frictionally tight insertion through receiving hole(s) in the rod. The flexible line members are preferably non-round in cross sectional width, and the receiving holes are preferably round in diameter.

U.S. Pat. No. 6,247,837 Stir Stick

There is provided a new and useful device for use in stirring liquid within a container which container has an opening with a smaller circumference than a circumference of a body of the container. The device comprises a cylindrical rod having a first end and a second end. There is provided a coupler at the first end that is constructed so as to rotationally couple the rod to a rotation source. There is further provided a split in the rod extending longitudinally from an approximate mid-point of the rod to the second end to form mixing blades. A portion of the mixing blades proximate to the second end are constructed so as to spread apart during the rotation of the device.

U.S. Pat. No. 6,871,995 Drinking Vessel Stirrer

A finger operated and spring loaded stirring device mounted on a drinking vessel comprising a tab coupled to a paddle. Said paddle is submerged in a liquid content of said vessel, and having a planar curvature coincides with the drinking vessel wall contour, and moves in an arc linear motion about a fixed pivot when said tab is operated and released by a thumb finger of the same hand holding the drinking vessel.

U.S. Pat. No. 8,092,072 Disposable Cup with Rotating Spoon

The invention relates to a disposable cup with a rotating spoon comprising a container (1), a spoon (3), a lid (2) with a hole for the passage of the spoon and a sleeving (4) which can be coupled to one another. The spoon (3) consists of a rod having a paddle-shaped flare at one end and a series of bends near the other end which define a C-shaped layout, the central branch of which has a rib (12) with an intermediate groove and passes through the hole of the lid (2), the end part projecting with crank functions. A radial slit (7) with a length and width equal to or greater than the section of the paddle starts from the hole of the lid. The lid further has a mouth piece or drinking area (8) next to its periphery. The invention is applicable in café, hotel and restaurant establishments for drinking take-away hot beverages, such as coffee.

U.S. Pat. No. 9,381,476 Drink Dispenser

A carbonator including a sealed container, a carbonation flow path defining element located inside the sealed container and including a water inlet, a carbonation gas inlet and a carbonated water outlet, a carbonation rotor disposed along the carbonation flow path for mixing carbonation gas and water, thereby producing carbonated water, and directing the carbonated water through the carbonated water outlet into the interior of the sealed container, a water cooling coil disposed within the sealed container, a refrigerating coil disposed within the sealed container in direct heat exchange cooling engagement with the carbonated water and in indirect heat exchange cooling engagement with the water cooling coil via the carbonated water and a carbonated water circulating rotor disposed outside of the carbonation flow path defining element and being operative to circulate the carbonated water in heat exchange engagement with the water cooling coil and the refrigerating coil.

U.S. Patent Application No. US20050052947A1

The invention is directed to a stirring device which is simple in its construction, cost-effective to produce, and easily used and maintained with little effort. The device in an embodiment is a one-piece body member having a drill chuck to be selectively coupled for use with a drill to cause rotation of the body member. The body member has a plurality of apertures to hold multiple stir sticks of conventional design or other stirring mechanisms. The stir sticks or the like may be oriented in differing configurations to facilitate the stirring action of the plurality of sticks when rotated in the fluid.

None of the references discussed above include a stirring device that may be inserted into a drill, cordless screwdriver, or the like, while also including a clamp member on a distal end thereof for removably holding a stirring implement, such as a stirring stick for coffee, or a stirring paddle for paint. Thus, it would be desirable to provide a stirring bit that may be removably secured to a power tool for rotating the stirring bit, and to include a clamp for holding a stirring stick, paddle, or the like. Further, it would be desirable to provide a stirring bit that may be removed from a power tool for cleaning and storage.

[symbol]

### BRIEF SUMMARY OF THE INVENTION

In accordance with one aspect of the invention, a first embodiment of a stirring apparatus includes a power tool such as a drill or cordless screwdriver, and a stirring bit that may be removably inserted into the power tool in the conventional manner for stirring a liquid or any other material that requires stirring or agitation for proper use or consumption. The stirring bit, in a preferred embodiment, is a generally longitudinal structure having a first and a second end, where the first end includes a hexagonal cross section, similarly to any standard drill bit, and a second end that include a clamp mechanism. The clamp mechanism is used for attaching a stirring stick or paddle to the stirring bit.

In use, a user simply attaches the stirring bit to the power tool, similarly to the manner in which a drill bit is attached to a drill or cordless screwdriver. The user may then open the clamp, slide a stirring stick, stirring paddle, or the like, into the clamp and tighten the clamp. Then, the user inserts the stirring stick into the container of liquid or other mixable material, and engages the power tool so that the stirring bit and the stirring stick are rotating within the container and stirring the material contained therein. One advantage of this arrangement is that the stirring stick or paddle may be oriented so that it is positioned along the linear axis of the stirring bit, or it may be oriented at an angle with respect to the stirring bit. Additionally, multiple stirring sticks or paddles may be inserted into the clamp mechanism at any desired angle. After the stirring and mixing operation is complete, the user may simply remove the stirring stick or sticks from the clamp mechanism, and dispose of the stirring sticks (or they may be cleaned and reused, if desired.

In other embodiments, the stirring bit may include a beater or frothing mechanism, rather than the clamp mechanism. In this embodiment, the beater or frothing mechanism is used to stir and agitate the fluid by rotating the bit with the power tool, as described above. For instance, one common frothing mechanism is a generally round member that is attached to the second end (the distal end) of the stirring bit, and includes a spiraled wire thereabout. Essentially, the frothing bit is, in this embodiment, a metal ring with a spring extending around the metal ring. In this embodiment, the frothing mechanism or beater may be integrally formed with the stirring bit, or the stirring bit may have an attachment mechanism so that the beater or frothing portion may be removably attached, so that multiple agitating members may be used interchangeably with a single stirring bit.

### BRIEF DESCRIPTION OF THE DRAWINGS

These and other features, aspects, and advantages of the present invention will become better understood with regard to the following description, appended claims, and accompanying drawings where:

FIG. 1 is a perspective view of another embodiment of a stirring bit, having a first end with a generally hexagonal cross-section, and a second end consisting of a clamp including a pair of pinch members used to open the clamp by squeezing the pinch members together;

FIG. 2 is a perspective view of the stirring bit shown in FIG. 1, wherein the stirring bit is attached to a cordless screwdriver for mechanically rotating the stirring bit, and further showing a stirring stick removably held by the clamp for stirring a liquid, such as coffee, tea, or the like;

FIG. 3 is a side view of one embodiment of a stirring apparatus, including a cordless drill having a stirring/agitating bit with a first end having a generally is hexagonal cross-section that is received by the drill chuck, and further including a clamp member with tightening screws, wherein the clamp member is holding a paint stirring paddle;

FIG. 4 is an exploded side view of the stirring/agitating bit shown in FIG. 3, wherein the clamp member is in an open position for receiving the paint stirring paddle, and further showing a handle member for receiving the tightening screw on an opposed side of the clamp member from the tightening screw;

FIG. 5 is a side view of the stirring/agitating bit shown in FIG. 3, wherein the paint stirring paddle is removably secured to the clamp member;

FIG. 6 is a front view of the stirring/agitating bit shown in FIG. 3, wherein the paint stirring paddle is removably secured to the clamp member;

FIG. 7 is a front of the stirring/agitating bit shown in FIG. 3, wherein the paint stirring paddle is removably secured to the clamp member in an angular configuration; and

FIG. 8 is a front view of the stirring/agitating bit shown in FIG. 3, wherein a pair of paint stirring paddles are removably secured to the clamp member.

FIG. 9 is a perspective view of one embodiment of a stirring/frothing apparatus including a first end having a generally hexagonal cross-section for insertion into a drill or cordless screwdriver, and a shaft extending downwardly toward a second end having a circular configuration surrounded by a spiraling coil for stirring and/or frothing liquid such as coffee, or the like;

FIG. 10 is a perspective view of the embodiment of a stirring/frothing apparatus shown in FIG. 1, wherein the stirring/frothing apparatus is removably connected to a cordless screwdriver, which is used to mechanically rotate the stirring/frothing apparatus;

[symbol]

### DETAILED DESCRIPTION OF THE INVENTION

Overview

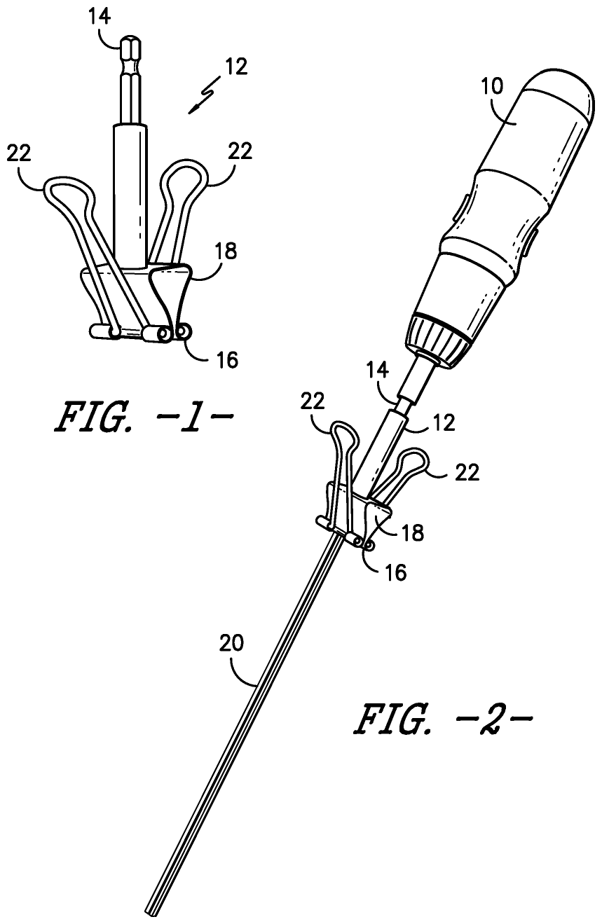

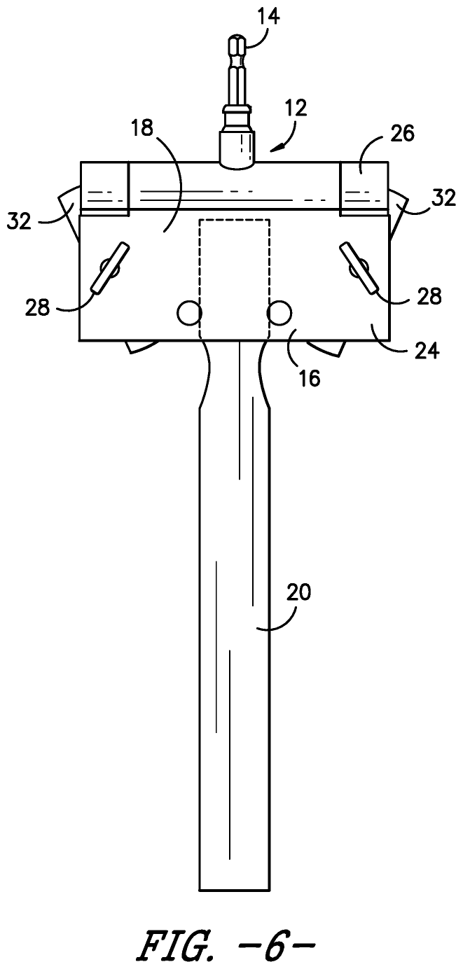

The present invention includes, in a first embodiment, a power tool 10 such as a drill or cordless screwdriver, and a stirring bit 12 that is removably secured to the power tool 10 for stirring a fluid or other material. The stirring bit 12, in a first embodiment as shown in FIGS. 1-8, is a longitudinal structure having a first end 14 and a second end 16. Preferably, the first end of the stirring bit includes a hexagonal cross section to facilitate attachment to a power tool 10, in a similar fashion as any standard drill bit. The second end 16 of the stirring bit includes a clamp 18 for holding a stirring tool 20, such as a stirring stick or paint paddle, or the like.

In use, a user simply attaches the stirring bit 12 to the power tool 10 in a conventional manner, and removably attaches a stirring tool 20 (or the like) to the clamp 18. The user then inserts the stirring tool 20 down into a container having a liquid or other mixable material therein, and engages the power tool 10 so that the stirring bit 12 rotates, thereby rotating the attached stirring tool 20 so that the stirring tool 20 is used to stir and agitate the liquid in the container. One advantage to this apparatus and method is that the stirring tool 20 may be disposed of after use, so that no cleaning is required.

Pinch Clamp Bit

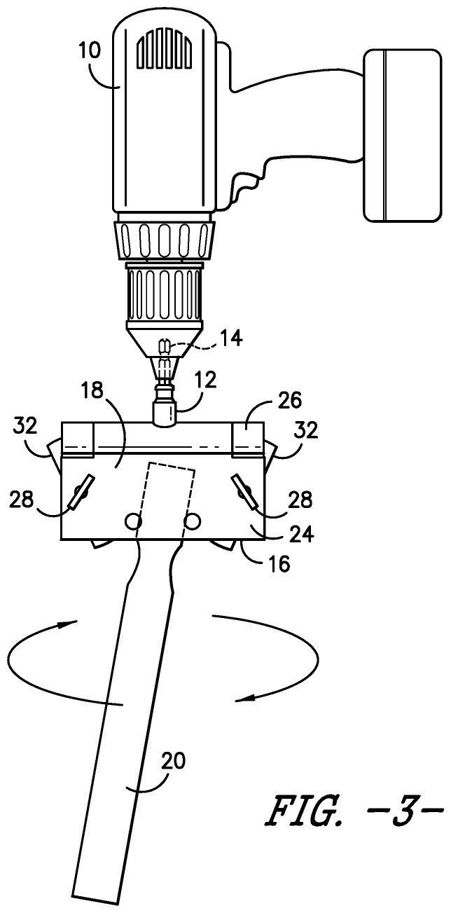

The clamp 18 may take many forms, depending on the intended use. In one embodiment that is particularly useful for small applications like starring coffee and mixed drinks, the clamp 18 may be a simple pinch clamp as shown in FIGS. 1 and 2, similar to paper binders, where a pair of pinch arms 22 extend outwardly from a rear portion of the clamp 18, and the clamp 18 is opened by pinching the pinch arms 22 toward one another. In this embodiment, the clamp 18 is biased in a closed position, and remains in the closed state until a user opens the clamp 18 by pinching the pinch arms 22 together.

Vise Clamp Bit

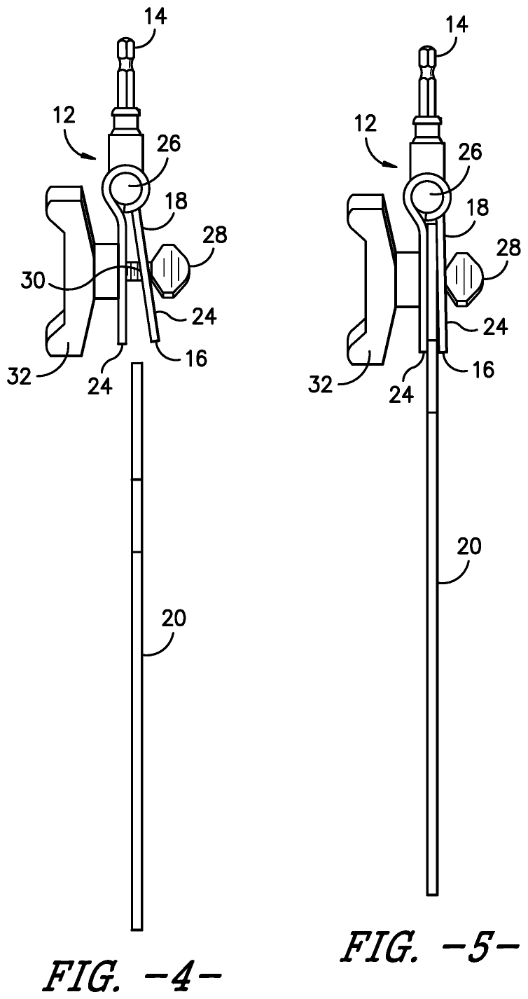

In other embodiments that are used for heavy duty jobs like stirring up concrete, paint, or the like, the clamp 18 may operate more like a vise, as shown in FIGS. 3-8. In this embodiment, the clamp 18 may be formed from a pair of panels 24 connected to form a hinge member 26 that freely opens and closes, and includes a securing mechanism 28 that applies a closing pressure to the clamp. The securing mechanism, in one embodiment, may include one or more threaded bolts 30 extending through holes on both panels 24, and wing nuts, knobs 32 or the like that are used to tighten the clamp 18 by screwing the knobs 32 tightly to the bolt 30 to hold the clamp 18 together.

Alternatively, the bolt 30 may be welded or fixed to the first panel 24 and extend through a hole in the second panel 24, where the knob 32 (or wing nut, or the like) is positioned on the outer portion of the second panel 24 and is used to tighten the second panel 24 down toward the first panel 24.

The examples of the clamp mechanism shown in FIGS. 1-8 are illustrative of clamp mechanisms that may be used, but it should be understand that any suitable clamping mechanism may be attached to the end of the stirring bit 12, either integrally or removably, so long as those clamp mechanisms are capable of temporarily securing a stirring tool 20 (stick, paddle, or the like) to the stirring bit 12 for the duration of a stirring or agitating operation.

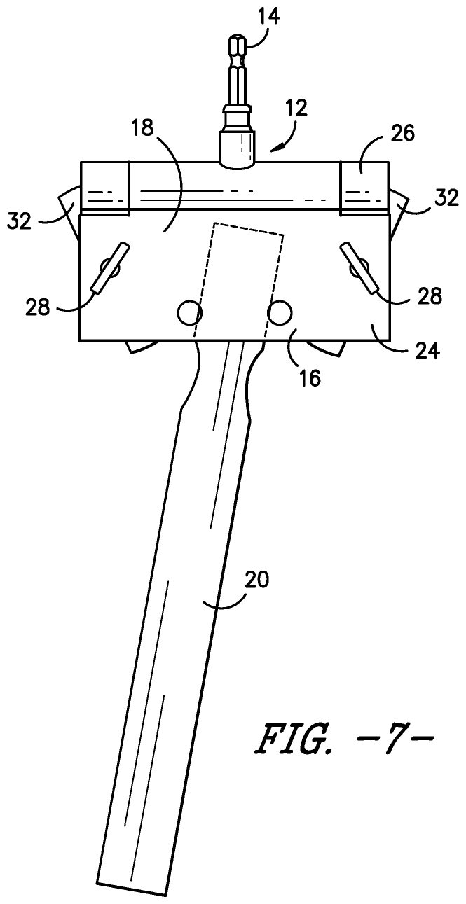

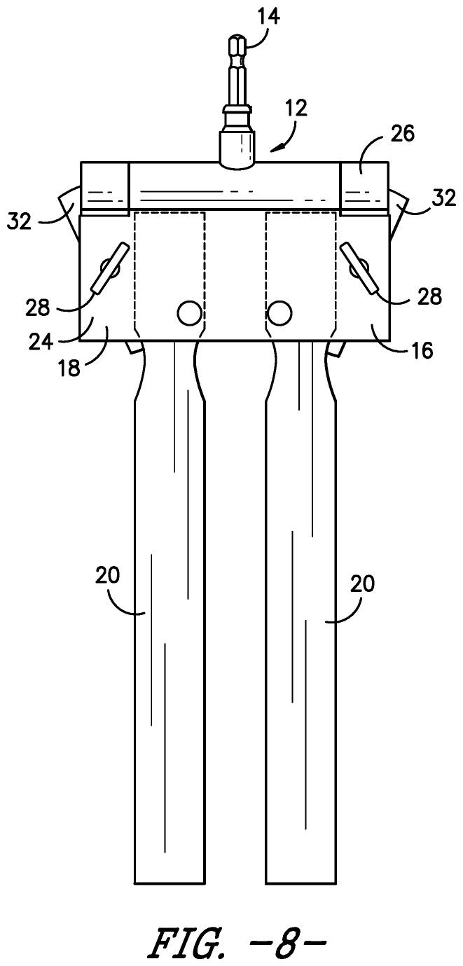

One particularly useful advantage of the present invention is that the stirring tools 20 that are attached to the stirring bit 12 may be oriented and positioned at any desired angle. For example, a stirring tool 20 may be attached to the clamp member 18 so that it is in a direct line with the axis of rotation of the bit 12, as shown in FIG. 6, or it may be disposed at an angle with respect to the bit, as shown in FIGS. 3 and 7. Multiple stirring tools 20 may be attached to the stirring bit 12 at one time, if desired, in any angular combination or configuration, as shown in FIG. 8. It is also contemplated that two stirring tools 20 may be held by the clamp 18 where the stirring tools 20 are oriented to form a V-shape, where the distal ends of the stirring tools 20 are oriented away from one another. Additionally, the upper portion of the stirring tools 20 may extend above the top of the clamp 18 at an angle, as desired.

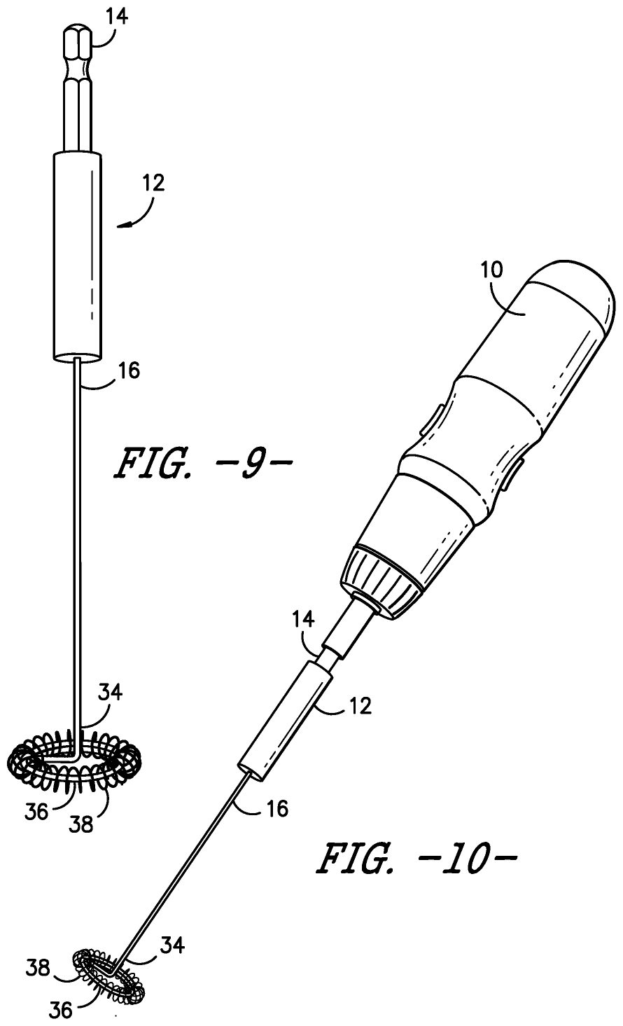

In another embodiment, the stirring bit 12 may include a beater or frothing mechanism 34, rather than the clamp mechanism. In this embodiment, the beater or frothing mechanism 34 is used to stir and agitate the fluid by rotating the bit 12 with the power tool 10, as described above. For instance, one common frothing mechanism is a generally round member that is attached to the second end (the distal end) of the stirring bit 12, and includes a spiraled wire thereabout, as shown in FIGS. 9-10. Essentially, the frothing mechanism 34 is, in this embodiment, a metal or plastic ring 36 with a spring or coiled wire 38 extending around the ring 36, as shown. In this embodiment, the frothing mechanism 34 or beater may be integrally formed with the stirring bit 12, or the stirring bit 12 may have an attachment mechanism so that the beater or frothing mechanism 34 may be removably attached thereto, so that multiple agitating members may be used interchangeably with a single stirring bit 12.

It should be understood that the stirring bit 12 may be made from any suitable material, but is preferably made from metal, such as aluminum or stainless steel. The stirring bit 12 may have any desired length or size, as desired.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A stirring bit comprising:
a longitudinal structure having a first end and a second end, wherein said first end is formed into a hexagonal cross section for insertion into a rotating portion of a power tool, and
a clamp mechanism positioned on said second end.

2. The stirring bit set forth in claim 1, wherein said clamp mechanism is biased toward a closed position, and includes a pair of pinch members attached thereto, wherein said clamp mechanism may be opened by pinching said pinch members, and wherein said clamp mechanism may close by releasing said pinch members.

2. The stirring bit set forth in claim 1, wherein said clamp mechanism includes a first panel and a second panel in hinged relation, and further includes a securing mechanism for tightening said clamp member against an object that is being held by said clamp member.

4. The stirring bit set forth in claim 3, wherein said first and second panels define at least one holes therein, and wherein said securing mechanism includes a threaded bolt extending through said holes in said first and second panels, and a pair of nuts screwed onto either end of said threaded bolt, so that said clamp may be tightened against an object being held by said clamp by tightening said nuts against outer portions of said panels.

5. The stirring bit set forth in claim 4, wherein at least one of said nuts is a wing nut.

6. The stirring bit set forth in claim 4, wherein at least one said nut includes a knob member.

7. The stirring bit set forth in claim 1, further in including a stirring tool that is removably attached to said clamp member.

8. A stirring bit comprising:
a longitudinal structure having a first end and a second end, wherein said first end is formed into a hexagonal cross section for insertion into a rotating portion of a power tool, and
wherein said second end includes a frothing mechanism.

9. The stirring bit set forth in claim 8, wherein said frothing mechanism includes a ring portion on a distal end of said stirring bit, and includes a coiled member that surrounds said circular portion so that said ring portion extends through a center of said coiled member.

10. The stirring bit set forth in claim 8, wherein said frothing mechanism is removable from said stirring bit.
